(19) United States
(12) Patent Application Publication
(10) Pub. No.: US 2025/0256434 A1
(43) Pub. Date: Aug. 14, 2025

(54) POLYMER FILM AND LAMINATE

(71) Applicant: FUJIFILM Corporation, Tokyo (JP)

(72) Inventors: Yasuyuki SASADA, Kanagawa (JP); Miyoko Shibano, Kanagawa (JP); Keita Takahashi, Kanagawa (JP)

(73) Assignee: FUJIFILM Corporation, Tokyo (JP)

(21) Appl. No.: 19/190,759

(22) Filed: Apr. 27, 2025

Related U.S. Application Data
(63) Continuation of application No. PCT/JP2023/034982, filed on Sep. 26, 2023.

(30) Foreign Application Priority Data
Oct. 31, 2022 (JP) 2022-175012

(51) Int. Cl. B29C 41/22; B29C 41/00; B29K 77/00; B29K 96/04; B29K 105/00; B32B 15/01; B32B 15/04; B32B 37/16

(52) U.S. Cl. CPC B29C 41/22; B29C 41/003; B32B 15/015; B32B 15/043; B32B 37/16; B29K 2077/10; B29K 2096/04; B29K 2105/0073; B29K 2105/0079; B29K 2995/0006; B29K 2995/0068; B32B 2250/02; B32B 2255/06; B32B 2255/26; B32B 2255/28; B32B 2307/204; B32B 2311/12

(57) ABSTRACT

A polymer film, in which in a case where a moisture transmission rate at 80° C. and a relative humidity of 90% in a first direction parallel to a main surface is defined as a first moisture transmission rate and a moisture transmission rate at 80° C. and a relative humidity of 90% in a second direction which is a thickness direction orthogonal to the first direction is defined as a second moisture transmission rate, a ratio of the first moisture transmission rate to the second moisture transmission rate is more than 1.00.

### CROSS-REFERENCE TO RELATED APPLICATION

This application is a Continuation of International Application No. PCT/JP2023/034982, filed Sep. 26, 2023, which claims priority to Japanese Patent Application No. 2022-175012 filed Oct. 31, 2022. Each of the above applications is hereby expressly incorporated by reference, in its entirety, into the present application.

### BACKGROUND OF THE INVENTION

### 1. Field of the Invention

The present disclosure relates to a polymer film and a laminate.

### 2. Description of the Related Art

In recent years, frequencies used in a communication equipment tend to be extremely high. In order to suppress transmission loss in a high frequency band, insulating materials used in a circuit board are required to have a lowered relative permittivity and a lowered dielectric loss tangent. A copper-clad laminated plate is suitably used as a member constituting a circuit board, and a polymer film is suitably used for manufacturing the copper-clad laminated plate.

For example, JP1994-297648A (JP-H6-297648A) discloses a moisture permeable laminated film which is a laminated film of a high moisture permeable film layer (A) and a low moisture permeable film layer (B), in which, in a case where moisture permeabilities (g/m²·24 hr) of the high moisture permeable film layer (A) and the low moisture permeable film layer (B) at a temperature of 40° C. and a relative humidity of 90% RH based on JIS Z0208 are respectively Pa and Pb, Pa is 300 or more, Pb is 100 or more, and Pa is 3 times or more of Pb.

JP2017-213721A discloses a laminated sheet comprising a base material sheet having moisture permeability, and a moisture permeable water absorbing layer laminated on the base material sheet, in which the moisture permeable water absorbing layer has a layer thickness of 3.5 μm or more, an air permeability of 99999 sec/100 ml or more based on JIS P8117, and a moisture permeability resistance of 300 m²·h·mmHg/g or more based on JIS A1324 at a temperature of 25° C. and a humidity of 50%.

### SUMMARY OF THE INVENTION

Typically, a copper-clad laminated plate is manufactured by laminating a copper foil on a surface of a polymer film. In addition, the wiring board is manufactured by superimposing a copper-clad laminated plate and a wiring base material such that a polymer film in the copper-clad laminated plate and the wiring base material are in contact with each other. In a case of manufacturing a wiring board, from the viewpoint of adhesiveness, it is required that the polymer film deforms by following the step formed on the surface of the wiring base material.

On the other hand, in a case where a polymer film having excellent step followability with respect to the wiring base material is used for the copper-clad laminated plate, interlayer peeling may occur in a reflow soldering step performed in a case of mounting an electronic component. Therefore, it has been required to achieve both excellent step followability with respect to the wiring base material and excellent adhesiveness during reflow soldering (that is, excellent heat resistance).

An object to be achieved by an embodiment of the present invention is to provide a polymer film having excellent step followability and excellent heat resistance.

An object to be achieved by another embodiment of the present invention is to provide a laminate using the above-described polymer film.

The means for achieving the above-described objects include the following aspects.

<1>

### A Polymer Film

in which in a case where a moisture transmission rate at 80° C. and a relative humidity of 90% in a first direction parallel to a main surface is defined as a first moisture transmission rate and a moisture transmission rate at 80° C. and a relative humidity of 90% in a second direction which is a thickness direction orthogonal to the first direction is defined as a second moisture transmission rate,
a ratio of the first moisture transmission rate to the second moisture transmission rate is more than 1.00.
   <2>

The polymer film according to <1>, in which the polymer film has a dielectric loss tangent of 0.01 or less.

<3>

The polymer film according to <1>, further including: a substance having an aspect ratio of 1.1 or more.

<4>

The polymer film according to <3>,
in which in a case where an absorbance of the substance in the first direction is defined as a first absorbance and an absorbance of the substance in the second direction is defined as a second absorbance,
a ratio of the first absorbance to the second absorbance is more than 1.00.
   <5>

The polymer film according to any one of <1> to <4>, further including: a layer A; and a layer B provided on at least one surface of the layer A.

<6>

The polymer film according to <5>, in which at least one of the layer A or the layer B contains a polymer having a dielectric loss tangent of 0.01 or less.

<7>

The polymer film according to <6>, in which the polymer having a dielectric loss tangent of 0.01 or less contains a liquid crystal polymer.

<8>

The polymer film according to <7>, in which the liquid crystal polymer contains an aromatic polyester amide.

<9>

The polymer film according to any one of <5> to <8>,
in which the layer A contains a polymer having a dielectric loss tangent of 0.01 or less, and
the layer B contains a thermoplastic resin containing a constitutional unit based on a monomer having an aromatic hydrocarbon group.
   <10>

A polymer film including:
a layer having a moisture permeability of more than 560 g/(m²·day) at a temperature of 80° C. and a relative humidity of 90% in a case of being converted to a film thickness of 50 μm,
in which the polymer film has a dielectric loss tangent of the polymer film of 0.01 or less.
   <11>

The polymer film according to <10>, in which the polymer film has a moisture absorption rate of 2.5% or less at a temperature of 25° C. and a relative humidity of 80%.

<12>

The polymer film according to <10> or <11>, further including:
a layer A, and a layer B provided on at least one surface of the layer A,
in which at least one of the layer A or the layer B is the layer having a moisture permeability of more than 560 g/(m²·day) at a temperature of 80° C. and a relative humidity of 90% in a case of being converted to a film thickness of 50 μm.
   <13>

The polymer film according to <12>, in which at least one of the layer A or the layer B includes a void.

<14>

The polymer film according to <12> or <13>, in which at least one of the layer A or the layer B contains a polymer having a dielectric loss tangent of 0.01 or less.

<15>

The polymer film according to <14>, in which the polymer having a dielectric loss tangent of 0.01 or less contains a liquid crystal polymer.

<16>

The polymer film according to <15>, in which the liquid crystal polymer contains an aromatic polyester amide.

<17>

The polymer film according to any one of <12> to <16>,
in which the layer A contains a polymer having a dielectric loss tangent of 0.01 or less, and
the layer B contains a thermoplastic resin containing a constitutional unit based on a monomer having an aromatic hydrocarbon group.
   <18>

A laminate including: the polymer film according to any one of <1> to <17>; and a metal layer or a metal wire disposed on at least one surface of the polymer film.

<19>

The laminate according to <18>, in which a peel strength between the polymer film and the metal layer or the metal wire is 0.5 kN/m or more.

According to an embodiment of the present invention, it is possible to provide a polymer film having excellent step followability and excellent heat resistance.

Further, according to another aspect of the present invention, it is possible to provide a laminate using the above-described polymer film.

### DESCRIPTION OF THE PREFERRED EMBODIMENTS

Hereinafter, the contents of the present disclosure will be described in detail. The description of configuration requirements below is made based on representative embodiments of the present disclosure in some cases, but the present disclosure is not limited to such embodiments.

In the present specification, a numerical range shown using “to” indicates a range including numerical values described before and after “to” as a lower limit value and an upper limit value.

In a numerical range described in a stepwise manner in the present disclosure, an upper limit value or a lower limit value described in one numerical range may be replaced with an upper limit or a lower limit in another numerical range described in a stepwise manner. In addition, in a numerical range described in the present disclosure, an upper limit value or a lower limit value described in the numerical range may be replaced with a value described in an example.

In addition, in a case where substitution or unsubstitution is not noted in regard to the notation of a “group” (atomic group) in the present specification, the “group” includes not only a group that does not have a substituent but also a group having a substituent. For example, the concept of an “alkyl group” includes not only an alkyl group that does not have a substituent (unsubstituted alkyl group) but also an alkyl group having a substituent (substituted alkyl group).

In the present specification, the concept of “(meth)acryl” includes both acryl and methacryl, and the concept of “(meth)acryloyl” includes both acryloyl and methacryloyl.

Further, the term “step” in the present specification indicates not only an independent step but also a step which cannot be clearly distinguished from other steps as long as the intended purpose of the step is achieved.

Furthermore, in the present disclosure, a combination of two or more preferred embodiments is a more preferred embodiment.

In addition, the weight-average molecular weight (Mw) and the number-average molecular weight (Mn) in the present disclosure are molecular weights converted using polystyrene as a standard substance by performing detection with a gel permeation chromatography (GPC) analysis apparatus using TSKgel SuperHM-H (trade name, manufactured by Tosoh Corporation) column, a solvent of pentafluorophenol (PFP) and chloroform at a mass ratio of 1:2, and a differential refractometer, unless otherwise specified.

### [Polymer Film]

In the polymer film according to the first embodiment of the present disclosure, in a case where a moisture transmission rate at 80° C. and a relative humidity of 90% in a first direction parallel to a main surface is defined as a first moisture transmission rate, and a moisture transmission rate at 80° C. and a relative humidity of 90% in a second direction which is a thickness direction orthogonal to the first direction is defined as a second moisture transmission rate, a ratio of the first moisture transmission rate to the second moisture transmission rate is more than 1.00.

The polymer film according to the second embodiment of the present disclosure includes a layer having a moisture permeability of more than 560 g/(m²·day) in a case of being converted to a film thickness of 50 μm at a temperature of 80° C. and a relative humidity of 90%, and has a dielectric loss tangent of 0.01 or less.

As a result of intensive studies, the inventors of the present invention have found that a polymer film having excellent step followability and excellent heat resistance can be provided by adopting the above-described configuration.

The detailed mechanism that brings about the aforementioned effect is unclear, but is assumed to be as below.

In the polymer film according to the first embodiment of the present disclosure, the ratio of the first moisture transmission rate to the second moisture transmission rate is more than 1.00. As a result, moisture is easily released in the first direction parallel to the main surface, and moisture is less likely to be accumulated inside the polymer film. Therefore, it is considered that the interlayer peeling caused by vaporization of moisture due to heating can be suppressed.

In addition, the polymer film according to the second embodiment of the present disclosure includes a layer having a moisture permeability of more than 560 g/(m²·day) in a case of being converted to a film thickness of 50 μm at a temperature of 80° C. and a relative humidity of 90%, and since the diffusion rate of moisture inside the polymer film is fast, moisture is less likely to be locally accumulated and is easily released. Therefore, it is considered that the interlayer peeling caused by vaporization of moisture due to heating can be suppressed.

In both the polymer film according to the first embodiment of the present disclosure and the polymer film according to the second embodiment of the present disclosure, interlayer peeling caused by vaporization of moisture due to heating can be suppressed, and heat resistance is excellent.

On the other hand, JP1994-297648A (JP-H06-297648A) and JP2017-213721A do not disclose a description focusing on both the step followability and the heat resistance.

### First Embodiment

In the polymer film according to the first embodiment of the present disclosure, in a case where a moisture transmission rate at 80° C. and a relative humidity of 90% in a first direction parallel to a main surface is defined as a first moisture transmission rate, and a moisture transmission rate at 80° C. and a relative humidity of 90% in a second direction which is a thickness direction orthogonal to the first direction is defined as a second moisture transmission rate, a ratio of the first moisture transmission rate to the second moisture transmission rate is more than 1.00. As a result, moisture is easily released in the first direction parallel to the main surface, and moisture is less likely to be accumulated inside the polymer film.

The “main surface” refers to a surface having the largest area in the polymer film, and generally, the film has two surfaces facing each other. In addition, the “first direction” is an in-plane direction parallel to the main surface, and the “second direction” is a film thickness direction.

From the viewpoint of further improving the heat resistance, the ratio of the first moisture transmission rate to the second moisture transmission rate is preferably 1.50 or more and more preferably 2.00 or more. An upper limit value of the ratio is not particularly limited, and is, for example, 100.

In the present disclosure, the first moisture transmission rate and the second moisture transmission rate are measured by the following method.

The moisture permeability of the entire polymer film is measured using a polymer film obtained by removing a copper foil of a copper-clad laminated plate with an aqueous solution of ferric chloride, washing the copper foil with pure water, and drying the copper foil.

In addition, the moisture permeability of each layer is measured by the following method. First, one copper foil of the double-sided copper-clad laminated plate is removed with an aqueous solution of ferric chloride, washed with pure water, and then scraped off with a razor. The other copper foil is removed with an aqueous solution of ferric chloride and washed with pure water. The moisture permeability of each layer is measured using a portion obtained by drying. In addition, since the moisture permeability changes depending on the film thickness, the measured moisture permeability is multiplied by the measured film thickness and divided by 50 to obtain the “moisture permeability in a case of being converted to a moisture permeability in a case where the film thickness is 50 μm”.

### (First Moisture Permeability)

The copper foil of the copper-clad laminated plate is removed with an aqueous solution of ferric chloride, washed with pure water, and dried to obtain a polymer film. The obtained polymer film is laminated and then subjected to thermal compression bonding using a vacuum press device to prepare a block-shaped sample, and the obtained sample is cut in the normal direction of the film and polished to prepare a sample for evaluation having a thickness of 1 mm. The first moisture permeability can be obtained from the mass change before and after setting the sample for evaluation in a moisture permeation cup having an inner diameter of 20 mmφ containing calcium chloride and placing the moisture permeation cup in a constant temperature and humidity device at a temperature of 80° C. and a relative humidity of 90% for 240 hours.

### (Second Moisture Permeability)

With reference to a moisture permeability test (cup method) of JIS Z 0208:1976, the second moisture permeability can be obtained from the mass change before and after setting the polymer film in a moisture permeation cup having an inner diameter of 20 mmφ containing calcium chloride and placing the moisture permeation cup in a constant temperature and humidity device at a temperature of 80° C. and a relative humidity of 90% for 24 hours.

Examples of the method of setting the ratio of the first moisture transmission rate to the second moisture transmission rate to be more than 1.00 include a method of adding a substance having an aspect ratio of 1.1 or more to the inside of the polymer film to promote the plane alignment; a method of forming a void or groove extending in the in-plane direction inside the polymer film or in the vicinity of the interface between the polymer film and the metal foil; and a method of embedding hollow fibers or the like inside the polymer film.

The dielectric loss tangent of the polymer film according to the first embodiment of the present disclosure is preferably 0.01 or less, more preferably 0.005 or less, and still more preferably more than 0 and 0.003 or less.

In the present disclosure, the dielectric loss tangent is measured by the following method.

The dielectric loss tangent is measured by a resonance perturbation method at a frequency of 10 GHz. A 10 GHz cavity resonator (“CP531” manufactured by Kanto Electronic Application and Development Inc.) is connected to a network analyzer (“E8363B” manufactured by Agilent Technology Co., Ltd.), a polymer film is inserted into the cavity resonator, and the dielectric loss tangent is measured from change in resonance frequency before and after insertion for 96 hours under an environment of a temperature of 25° C. and humidity of 60% RH.

From the viewpoint of setting the ratio of the first moisture transmission rate to the second moisture transmission rate to be more than 1.00, the polymer film according to the first embodiment of the present disclosure preferably contains a substance having an aspect ratio of 1.1 or more.

The aspect ratio is a ratio of a major axis to a minor axis of a substance, and can be measured, for example, from a projection view of the substance obtained from a microphotograph.

In the substance having an aspect ratio of 1.1 or more, the kind of the substance is not particularly limited, and an organic filler or an inorganic filler is preferable. Examples thereof include a carbon nanotube and a layered clay mineral. Examples of the layered clay mineral include smectite (hectolite, saponite, stevensite, beidellite, montmorillonite), mica, and the like, which may be a natural product, may be chemically synthesized, or may be a substitute, a derivative, or a mixture thereof.

From the viewpoint of setting the ratio of the first moisture transmission rate to the second moisture transmission rate to be more than 1.00, the aspect ratio of the substance is preferably 1.5 or more and more preferably 2.0 or more. The upper limit value of the aspect ratio is not particularly limited, and is, for example, 10,000.

From the viewpoint of the step followability and the heat resistance, the content of the substance having an aspect ratio of 1.1 or more is preferably 5% by volume to 70% by volume and more preferably 10% by volume to 50% by volume with respect to the total mass of the polymer film.

In the polymer film according to the first embodiment of the present disclosure, in a case where an absorbance of the substance in the first direction is defined as a first absorbance and an absorbance of the substance in the second direction is defined as a second absorbance, it is preferable that a ratio of the first absorbance to the second absorbance is more than 1.00. Hereinafter, the ratio of the first absorbance to the second absorbance is also referred to as dichroic ratio.

In the present disclosure, the dichroic ratio is measured by the following method.

The dichroic ratio of the substance having an aspect ratio of 1.1 or more, which is contained in the film, can be calculated by the following formula using the characteristic absorption derived from the substance by a polarization ATR-IR method described below from a ratio of an in-plane absorbance (first absorbance) and an out-of-plane absorbance (second absorbance) as first absorbance/(second absorbance×2).

Using a Fourier transform infrared spectrometer NICOLET 6700 (manufactured by Thermo Fisher Scientific, Inc.) equipped with MKII Golden Gate Single Reflection ATR System (germanium crystal, incidence angle of 45°, manufactured by Specac Ltd.), which is a single reflection ATR prism, and a wire grid polarizer, in an environment of a temperature of 25° C. and a relative humidity of 60%, an absorption intensity measured with polarization parallel to the sample surface is defined as a first intensity, and an absorption intensity measured with polarization perpendicular to the sample surface is defined as a second intensity. In addition, the pressing pressure of the sample can be adjusted by interposing a silicon rubber between the pressing jig and the sample, so that the reproducibility of the adhesion between the sample and the prism can be obtained.

The polymer film according to the first embodiment of the present disclosure may be a single layer or may be two or more layers, and from the viewpoint of step followability and heat resistance, it is preferable that the polymer film is two or more layers. That is, the polymer film according to the first embodiment of the present disclosure preferably includes the layer A and the layer B provided on at least one surface of the layer A. The layer B is preferably a surface layer (outermost layer).

The components contained in the layer A and the layer B are not particularly limited, but it is preferable that the layer A and the layer B contain at least one polymer. From the viewpoint of dielectric loss tangent of the polymer film, it is preferable that at least one of the layer A or the layer B contains a polymer having a dielectric loss tangent of 0.01 or less.

The layer A and the layer B may contain only one kind of polymer having a dielectric loss tangent of 0.01 or less, or may contain two or more kinds thereof.

From the viewpoint of the dielectric loss tangent of the polymer film, the dielectric loss tangent of the polymer having a dielectric loss tangent of 0.01 or less is preferably 0.005 or less and more preferably more than 0 and 0.003 or less.

Examples of the polymer having a dielectric loss tangent of 0.01 or less include thermoplastic resins such as a liquid crystal polymer, a fluororesin, a polymerized substance of a compound which has a cyclic aliphatic hydrocarbon group and a group having an ethylenically unsaturated bond, polyether ether ketone, polyolefin, polyamide, polyester, polyphenylene sulfide, polyether ketone, polycarbonate, polyethersulfone, polyphenylene ether and a modified product thereof, and polyetherimide; elastomers such as a copolymer of glycidyl methacrylate and polyethylene; and thermosetting resins such as a phenol resin, an epoxy resin, a polyimide, and a cyanate resin.

### —Liquid Crystal Polymer—

From the viewpoint of dielectric loss tangent of the polymer film, the polymer having a dielectric loss tangent of 0.01 or less is preferably a liquid crystal polymer. That is, it is preferable that at least one of the layer A or the layer B contains a liquid crystal polymer.

The kind of the liquid crystal polymer is not particularly limited, and a known liquid crystal polymer can be used.

In addition, the liquid crystal polymer may be a thermotropic liquid crystal polymer which exhibits liquid crystallinity in a molten state, or may be a lyotropic liquid crystal polymer which exhibits liquid crystallinity in a solution state. In addition, in a case of the thermotropic liquid crystal, it is preferable that the liquid crystal is melted at a temperature of 450° C. or lower.

Examples of the liquid crystal polymer include a liquid crystal polyester, a liquid crystal polyester amide in which an amide bond is introduced into the liquid crystal polyester, a liquid crystal polyester ether in which an ether bond is introduced into the liquid crystal polyester, and a liquid crystal polyester carbonate in which a carbonate bond is introduced into the liquid crystal polyester.

In addition, as the liquid crystal polymer, from the viewpoint of liquid crystallinity, a polymer having an aromatic ring is preferable, and an aromatic polyester or an aromatic polyester amide is more preferable.

Furthermore, the liquid crystal polymer may be a polymer in which an imide bond, a carbodiimide bond, a bond derived from an isocyanate, such as an isocyanurate bond, or the like is further introduced into the aromatic polyester or the aromatic polyester amide.

In addition, it is preferable that the liquid crystal polymer is a fully aromatic liquid crystal polymer formed of only an aromatic compound as a raw material monomer.

Examples of the liquid crystal polymer include the following liquid crystal polymers.

1) a liquid crystal polymer obtained by polycondensing (i) an aromatic hydroxycarboxylic acid, (ii) an aromatic dicarboxylic acid, and (iii) at least one compound selected from the group consisting of an aromatic diol, an aromatic hydroxyamine, and an aromatic diamine.

2) a liquid crystal polymer obtained by polycondensing a plurality of kinds of aromatic hydroxycarboxylic acids.

3) a liquid crystal polymer obtained by polycondensing (i) an aromatic dicarboxylic acid and (ii) at least one compound selected from the group consisting of an aromatic diol, an aromatic hydroxyamine, and an aromatic diamine.

4) a liquid crystal polymer obtained by polycondensing (i) polyester such as polyethylene terephthalate and (ii) an aromatic hydroxycarboxylic acid.

Here, the aromatic hydroxycarboxylic acid, the aromatic dicarboxylic acid, the aromatic diol, the aromatic hydroxyamine, and the aromatic diamine may be each independently replaced with a polycondensable derivative.

A melting point of the liquid crystal polymer is preferably equal to or higher than 250° C., more preferably 250° C. to 350° C., and still more preferably 260° C. to 330° C.

In the present disclosure, the melting point is measured using a differential scanning calorimetry device. For example, the measurement is performed using product name “DSC-60A Plus” (manufactured by Shimadzu Corporation). A temperature increase rate in the measurement is set to 10° C./minute.

The weight-average molecular weight of the liquid crystal polymer is preferably equal to or less than 1,000,000, more preferably 3,000 to 300,000, still more preferably 5,000 to 100,000, and particularly preferably 5,000 to 30,000.

The liquid crystal polymer preferably includes aromatic polyester amide from a viewpoint of further decreasing the dielectric loss tangent. That is, it is preferable that at least one of the layer A or the layer B contains an aromatic polyester amide.

Aromatic polyester amide is resin having at least one aromatic ring and having an ester bond and an amide bond. Among these, from the viewpoint of heat resistance, the aromatic polyester amide is preferably a fully aromatic polyester amide.

Aromatic polyester amide is preferably a crystalline polymer. The polymer film according to the present disclosure preferably contains a crystalline aromatic polyester amide. Aromatic polyester amide included in the film is crystalline, whereby the dielectric loss tangent further decreases.

The crystalline polymer refers to a polymer having a clear endothermic peak, not a stepwise endothermic amount changed, in differential scanning calorimetry (DSC). Specifically, for example, this means that a half-width of an endothermic peak in measuring at a temperature increase rate 10° C./minute is within 10° C. A polymer in which a half-width exceeds 10° C. and a polymer in which a clear endothermic peak is not recognized are distinguished as an amorphous polymer from a crystalline polymer.

Aromatic polyester amide preferably contains a constitutional unit represented by Formula 1, a constitutional unit represented by Formula 2, and a constitutional unit represented by Formula 3.

—O—Ar1-CO Formula 1

—CO—Ar2-CO Formula 2

—NH—Ar3-O Formula 3

In Formula 1 to Formula 3, Ar1, Ar2, and Ar3 each independently represent a phenylene group, a naphthylene group, or a biphenylylene group.

Hereinafter, the constitutional unit represented by Formula 1 and the like are also referred to as “unit 1” and the like.

The unit 1 can be introduced, for example, using aromatic hydroxycarboxylic acid as a raw material.

The unit 2 can be introduced, for example, using aromatic dicarboxylic acid as a raw material.

The unit 3 can be introduced, for example, using aromatic hydroxylamine as a raw material.

Here, the aromatic hydroxycarboxylic acid, the aromatic dicarboxylic acid, the aromatic diol, and the aromatic hydroxylamine may be each independently replaced with a polycondensable derivative.

For example, the aromatic hydroxycarboxylic acid and the aromatic dicarboxylic acid can be replaced with aromatic hydroxycarboxylic acid ester and aromatic dicarboxylic acid ester, by converting a carboxy group into an alkoxycarbonyl group or an aryloxycarbonyl group.

The aromatic hydroxycarboxylic acid and the aromatic dicarboxylic acid can be replaced with aromatic hydroxycarboxylic acid halide and aromatic dicarboxylic acid halide, by converting a carboxy group into a haloformyl group.

The aromatic hydroxycarboxylic acid and the aromatic dicarboxylic acid can be replaced with aromatic hydroxycarboxylic acid anhydride and aromatic dicarboxylic acid anhydride, by converting a carboxy group into an acyloxycarbonyl group.

Examples of a polymerizable derivative of a compound having a hydroxy group, such as an aromatic hydroxycarboxylic acid and an aromatic hydroxyamine, include a derivative (acylated product) obtained by acylating a hydroxy group and converting the acylated group into an acyloxy group.

For example, the aromatic hydroxycarboxylic acid and the aromatic hydroxylamine can be each replaced with an acylated product by acylating a hydroxy group and converting the acylated group into an acyloxy group.

Examples of a polycondensable derivative of the aromatic hydroxylamine include a substance (acylated product) obtained by acylating an amino group to convert the amino group into an acylamino group.

For example, the aromatic hydroxyamine can be replaced with an acylated product by acylating an amino group and converting the acylated group into an acylamino group.

In Formula 1, Ar1 is preferably a p-phenylene group, a 2,6-naphthylene group, or a 4,4′-biphenylylene group, and more preferably a 2,6-naphthylene group.

In a case where Ar1 is a p-phenylene group, the unit 1 is, for example, a constitutional unit derived from p-hydroxybenzoic acid.

In a case where Ar1 is a 2,6-naphthylene group, the unit 1 is, for example, a constitutional unit derived from 6-hydroxy-2-naphthoic acid.

In a case where Ar1 is a 4,4′-biphenylylene group, the unit 1 is, for example, a constitutional unit derived from 4′-hydroxy-4-biphenylcarboxylic acid.

In Formula 2, Ar2 is preferably a p-phenylene group, an m-phenylene group, or a 2,6-naphthylene group, and more preferably an m-phenylene group.

In a case where Ar2 is a p-phenylene group, the unit 2 is, for example, a constitutional unit derived from terephthalic acid.

In a case where Ar2 is an m-phenylene group, the unit 2 is, for example, a constitutional unit derived from isophthalic acid.

In a case where Ar2 is a 2,6-naphthylene group, the unit 2 is, for example, a constitutional unit derived from 2,6-naphthalenedicarboxylic acid.

In Formula 3, Ar3 is preferably a p-phenylene group or a 4,4′-biphenylylene group, and more preferably a p-phenylene group.

In a case where Ar3 is a p-phenylene group, the unit 2 is, for example, a constitutional unit derived from p-aminophenol.

In a case where Ar3 is a 4,4′-biphenylylene group, the unit 2 is, for example, a constitutional unit derived from 4-amino-4′-hydroxybiphenyl.

With respect to the total content of the unit 1, the unit 2, and the unit 3, a content of the unit 1 is preferably 30 mol % or more, a content of the unit 2 is preferably 35% or less, and a content of the unit 3 is preferably 35 mol % or less.

The content of the unit 1 is preferably 30 mol % to 80 mol %, more preferably 30 mol % to 60 mol %, and particularly preferably 30 mol % to 40 mol % with respect to the total content of the unit 1, the unit 2, and the unit 3.

The content of the unit 2 is preferably 10 mol % to 35 mol %, more preferably 20 mol % to 35 mol %, and particularly preferably 30 mol % to 35 mol % with respect to the total content of the unit 1, the unit 2, and the unit 3.

The content of the unit 3 is preferably 10 mol % to 35 mol %, more preferably 20 mol % to 35 mol %, and particularly preferably 30 mol % to 35 mol % with respect to the total content of the unit 1, the unit 2, and the unit 3.

The total content of the constitutional units is a value obtained by totaling a substance amount (mol) of each constitutional unit. The substance amount of each constitutional unit is calculated by dividing a mass of each constitutional unit constituting aromatic polyester amide by a formula weight of each constitutional unit.

In a case where a ratio of the content of the unit 2 to the content of the unit 3 is expressed as [Content of unit 2]/[Content of unit 3] (mol/mol), the ratio is preferably 0.9/1 to 1/0.9, more preferably 0.95/1 to 1/0.95, and still more preferably 0.98/1 to 1/0.98.

Aromatic polyester amide may have two kinds or more of the unit 1 to the unit 3 each independently. Alternatively, aromatic polyester amide may have other constitutional units other than the unit 1 to the unit 3. A content of other constitutional units is preferably 10% by mole or less and more preferably 5% by mole or less with respect to the total content of all constitutional units.

Aromatic polyester amide is preferably produced by subjecting a source monomer corresponding to the constitutional unit constituting the aromatic polyester amide to melt polymerization.

The weight-average molecular weight of aromatic polyester amide is preferably equal to or less than 1,000,000, more preferably 3,000 to 300,000, still more preferably 5,000 to 100,000, and particularly preferably 5,000 to 30,000.

### —Fluororesin—

From the viewpoint of heat resistance and mechanical strength, the polymer having a dielectric loss tangent of 0.01 or less may be a fluororesin.

In the present disclosure, the kind of the fluororesin is not particularly limited, and a known fluororesin can be used.

Examples of the fluororesin include a homopolymer and a copolymer containing a constitutional unit derived from a fluorinated α-olefin monomer, that is, an α-olefin monomer containing at least one fluorine atom. In addition, examples of the fluororesin include a copolymer containing a constitutional unit derived from a fluorinated α-olefin monomer, and a constitutional unit derived from a non-fluorinated ethylenically unsaturated monomer reactive to the fluorinated α-olefin monomer.

Examples of the fluorinated α-olefin monomer include CF₂═CF₂, CHF—CF₂, CH₂—CF₂, CHCl═CHF, CClF—CF₂, CCl₂═CF₂, CClF═CClF, CHF═CCl₂, CH₂═CClF, CCl₂═CClF, CF₃CF═CF₂, CF₃CF═CHF, CF₃CH—CF₂, CF₃CH—CH₂, CHF₂CH—CHF, CF₃CF═CF₂, and perfluoro(alkyl having 2 to 8 carbon atoms) vinyl ether (for example, perfluoromethyl vinyl ether, perfluoropropyl vinyl ether, and perfluorooctyl vinyl ether). Among these, as the fluorinated α-olefin monomer, at least one monomer selected from the group consisting of tetrafluoroethylene (CF₂═CF₂), chlorotrifluoroethylene (CClF═CF₂), (perfluorobutyl)ethylene, vinylidene fluoride (CH₂═CF₂), and hexafluoropropylene (CF₂═CFCF₃) is preferable.

Examples of the non-fluorinated ethylenically unsaturated monomer include ethylene, propylene, butene, and an ethylenically unsaturated aromatic monomer (for example, styrene and a-methylstyrene).

The fluorinated α-olefin monomer may be used alone or in combination of two or more thereof.

In addition, the non-fluorinated ethylenically unsaturated monomer may be used alone or in combination of two or more thereof.

Examples of the fluororesin include polychlorotrifluoroethylene (PCTFE), poly(chlorotrifluoroethylene-propylene), poly(ethylene-tetrafluoroethylene) (ETFE), poly(ethylene-chlorotrifluoroethylene) (ECTFE), poly(hexafluoropropylene), poly(tetrafluoroethylene) (PTFE), poly(tetrafluoroethylene-ethylene-propylene), poly(tetrafluoroethylene-hexafluoropropylene) (FEP), poly(tetrafluoroethylene-propylene) (FEPM), poly(tetrafluoroethylene-perfluoropropylene vinyl ether), poly(tetrafluoroethylene-perfluoroalkyl vinyl ether) (PFA) (for example, poly(tetrafluoroethylene-perfluoropropyl vinyl ether)), polyvinyl fluoride (PVF), polyvinylidene fluoride (PVDF), poly(vinylidene fluoride-chlorotrifluoroethylene), perfluoropolyether, perfluorosulfonic acid, and perfluoropolyoxetane.

The fluororesin may have a constitutional unit derived from fluorinated ethylene or fluorinated propylene.

The fluororesin may be used alone or in combination of two or more thereof.

The fluororesin is preferably FEP, PFA, ETFE, or PTFE.

The FEP is available from Du Pont as the trade name of TEFLON (registered trademark) FEP or from DAIKIN INDUSTRIES, LTD. as the trade name of NEOFLON FEP. The PFA is available from DAIKIN INDUSTRIES, LTD. as the trade name of NEOFLON PFA, from Du Pont as the trade name of TEFLON (registered trademark) PFA, or from Solvay Solexis as the trade name of HYFLON PFA.

The fluororesin more preferably includes PTFE. The PTFE may be a PTFE homopolymer, a partially modified PTFE homopolymer, or a combination including one or both of these. The partially modified PTFE homopolymer preferably contains a constitutional unit derived from a comonomer other than tetrafluoroethylene in an amount of less than 1% by mass based on the total mass of the polymer.

The fluororesin may be a crosslinkable fluoropolymer having a crosslinkable group. The crosslinkable fluoropolymer can be crosslinked by a known crosslinking method in the related art. One of the representative crosslinkable fluoropolymers is a fluoropolymer having (meth)acryloyloxy. For example, the crosslinkable fluoropolymer can be represented by Formula: H₂C═CR′COO—(CH₂)ₙ—R—(CH₂)ₙ—OOCR′═CH₂.

In the formula, R is an oligomer chain having a constitutional unit derived from the fluorinated α-olefin monomer, R′ is H or —CH₃, and n is 1 to 4. R may be a fluorine-based oligomer chain having a constitutional unit derived from tetrafluoroethylene.

In order to initiate a radical crosslinking reaction through the (meth)acryloyloxy group in the fluororesin, by exposing the fluoropolymer having a (meth)acryloyloxy group to a free radical source, a crosslinked fluoropolymer network can be formed. The free radical source is not particularly limited, and suitable examples thereof include a photoradical polymerization initiator and an organic peroxide. Appropriate photoradical polymerization initiators and organic peroxides are well known in the art. The crosslinkable fluoropolymer is commercially available, and examples thereof include Viton B manufactured by Du Pont.

—Polymerized Substance of Compound which has Cyclic Aliphatic Hydrocarbon Group and Group Having Ethylenically Unsaturated Bond—

The polymer having a dielectric loss tangent of 0.01 or less may be a polymerized substance of a compound which has a cyclic aliphatic hydrocarbon group and a group having an ethylenically unsaturated bond.

Examples of the polymerized substance of a compound which has a cyclic aliphatic hydrocarbon group and a group having an ethylenically unsaturated bond include thermoplastic resins having a constitutional unit derived from a cyclic olefin monomer such as norbornene and a polycyclic norbornene-based monomer.

The polymerized substance of a compound which has a cyclic aliphatic hydrocarbon group and a group having an ethylenically unsaturated bond may be a ring-opened polymer of the above-described cyclic olefin, a hydrogenated product of a ring-opened copolymer using two or more cyclic olefins, or an addition polymer of a cyclic olefin and a linear olefin or aromatic compound having an ethylenically unsaturated bond such as a vinyl group. In addition, a polar group may be introduced into the polymerized substance of a compound which has a cyclic aliphatic hydrocarbon group and a group having an ethylenically unsaturated bond.

The polymerized substance of a compound which has a cyclic aliphatic hydrocarbon group and a group having an ethylenically unsaturated bond may be used alone or in combination of two or more thereof.

A ring structure of the cyclic aliphatic hydrocarbon group may be a single ring, a fused ring in which two or more rings are fused, or a crosslinked ring.

Examples of the ring structure of the cyclic aliphatic hydrocarbon group include a cyclopentane ring, a cyclohexane ring, a cyclooctane ring, an isophorone ring, a norbornane ring, and a dicyclopentane ring.

The compound which has a cyclic aliphatic hydrocarbon group and a group having an ethylenically unsaturated bond is not particularly limited, and examples thereof include a (meth)acrylate compound having a cyclic aliphatic hydrocarbon group, a (meth)acrylamide compound having a cyclic aliphatic hydrocarbon group, and a vinyl compound having a cyclic aliphatic hydrocarbon group. Among these, preferred examples thereof include a (meth)acrylate compound having a cyclic aliphatic hydrocarbon group. In addition, the compound which has a cyclic aliphatic hydrocarbon group and a group having an ethylenically unsaturated bond may be a monofunctional ethylenically unsaturated compound or a polyfunctional ethylenically unsaturated compound.

The number of cyclic aliphatic hydrocarbon groups in the compound which has a cyclic aliphatic hydrocarbon group and a group having an ethylenically unsaturated bond may be 1 or more, and may be 2 or more.

It is sufficient that the polymerized substance of a compound which has a cyclic aliphatic hydrocarbon group and a group having an ethylenically unsaturated bond is a polymer obtained by polymerizing at least one compound which has a cyclic aliphatic hydrocarbon group and a group having an ethylenically unsaturated bond, and it may be a polymerized substance of two or more kinds of the compound which has a cyclic aliphatic hydrocarbon group and a group having an ethylenically unsaturated bond or a copolymer with other ethylenically unsaturated compounds having no cyclic aliphatic hydrocarbon group.

In addition, the polymerized substance of a compound which has a cyclic aliphatic hydrocarbon group and a group having an ethylenically unsaturated bond is preferably a cycloolefin polymer.

### —Polyphenylene Ether—

The polymer having a dielectric loss tangent of 0.01 or less may be a polyphenylene ether.

In the polyphenylene ether, from the viewpoint of dielectric loss tangent and heat resistance, the average number of molecular terminal phenolic hydroxyl groups per molecule (the number of terminal hydroxyl groups) is preferably 1 to 5 and more preferably 1.5 to 3. The number of terminal hydroxyl groups in the polyphenylene ether can be found, for example, from a standard value of a product of the polyphenylene ether. In addition, the number of terminal hydroxyl groups is expressed as, for example, an average value of the number of phenolic hydroxyl groups per molecule of all polyphenylene ethers present in 1 mol of the polyphenylene ether.

The polyphenylene ether may be used alone or in combination of two or more thereof.

Examples of the polyphenylene ether include a polyphenylene ether including 2,6-dimethylphenol and at least one of bifunctional phenol or trifunctional phenol, and poly(2,6-dimethyl-1,4-phenylene oxide). More specifically, the polyphenylene ether is preferably a compound having a structure represented by Formula (PPE).

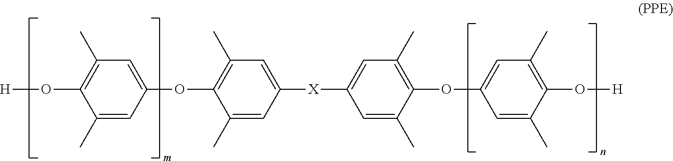

In Formula (PPE), X represents an alkylene group having 1 to 3 carbon atoms or a single bond, m represents an integer of 0 to 20, n represents an integer of 0 to 20, and the sum of m and n represents an integer of 1 to 30.

Examples of the alkylene group in X described above include a dimethylmethylene group.

In a case where heat curing is performed after film formation, from the viewpoint of heat resistance and film-forming property, a weight-average molecular weight (Mw) of the polyphenylene ether is preferably 500 to 5,000 and preferably 500 to 3,000. In addition, in a case where the heat curing is not performed, the weight-average molecular weight (Mw) of the polyphenylene ether is not particularly limited, but is preferably 3,000 to 100,000 and preferably 5,000 to 50,000.

### —Aromatic Polyether Ketone—

The polymer having a dielectric loss tangent of 0.01 or less may be an aromatic polyether ketone.

The aromatic polyether ketone is not particularly limited, and a known aromatic polyether ketone can be used.

The aromatic polyether ketone is preferably a polyether ether ketone.

The polyether ether ketone is one kind of the aromatic polyether ketone, and is a polymer in which bonds are arranged in the order of an ether bond, an ether bond, and a carbonyl bond. It is preferable that the bonds are linked to each other by a divalent aromatic group.

The aromatic polyether ketone may be used alone or in combination of two or more thereof.

Examples of the aromatic polyether ketone include polyether ether ketone (PEEK) having a chemical structure represented by Formula (P1), polyether ketone (PEK) having a chemical structure represented by Formula (P2), polyether ketone ketone (PEKK) having a chemical structure represented by Formula (P3), polyether ether ketone ketone (PEEKK) having a chemical structure represented by Formula (P4), and polyether ketone ether ketone ketone (PEKEKK) having a chemical structure represented by Formula (P5).

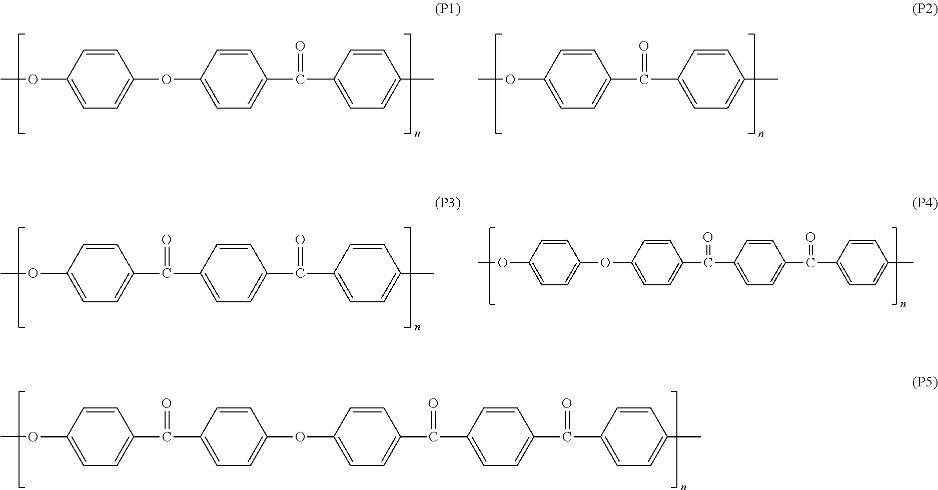

From the viewpoint of mechanical properties, each n of Formulae (P1) to (P5) is preferably 10 or more and more preferably 20 or more. On the other hand, from the viewpoint that the aromatic polyether ketone can be easily produced, n is preferably 5,000 or less and more preferably 1,000 or less. That is, n is preferably 10 to 5,000 and more preferably 20 to 1,000.

From the viewpoint of dielectric loss tangent of the polymer film, the content of the polymer having a dielectric loss tangent of 0.01 or less is preferably 10% by mass or more, more preferably 20% by mass or more, and particularly preferably 25% by mass to 98% by mass with respect to the total mass of the layer A.

From the viewpoint of dielectric loss tangent of the polymer film, the content of the polymer having a dielectric loss tangent of 0.01 or less is preferably 10% by mass or more, more preferably 15% by mass or more, and particularly preferably 20% by mass to 60% by mass with respect to the total mass of the layer B (a layer different from the layer A).

In addition, from the viewpoint of dielectric loss tangent and step followability of the polymer film, the layer A or the layer B preferably contains a thermoplastic resin. The thermoplastic resin may be a thermoplastic elastomer. The elastomer refers to a polymer compound exhibiting elastic deformation. That is, the elastomer corresponds to a polymer compound having a property of being deformed according to an external force in a case where the external force is applied and of being recovered to an original shape in a short time in a case where the external force is removed.

Examples of the thermoplastic resin include a polyurethane resin, a polyester resin, a (meth)acrylic resin, a polystyrene resin, a fluororesin, a polyimide resin, a fluorinated polyimide resin, a polyamide resin, a polyamideimide resin, a polyether imide resin, a cellulose acylate resin, a polyether ether ketone resin, a polycarbonate resin, a polyolefin resin (for example, a polyethylene resin, a polypropylene resin, a resin consisting of a cyclic olefin copolymer, and an alicyclic polyolefin resin), a polyarylate resin, a polyether sulfone resin, a polysulfone resin, a fluorene ring-modified polycarbonate resin, an alicyclic ring-modified polycarbonate resin, and a fluorene ring-modified polyester resin.

The thermoplastic elastomer is not particularly limited, and examples thereof include an elastomer including a constitutional repeating unit derived from styrene (polystyrene-based elastomer), a polyester-based elastomer, a polyolefin-based elastomer, a polyurethane-based elastomer, a polyamide-based elastomer, a polyacryl-based elastomer, a silicone-based elastomer, and a polyimide-based elastomer. The thermoplastic elastomer may be a hydride.

Examples of the polystyrene-based elastomer include a styrene-butadiene-styrene block copolymer (SBS), a styrene-isoprene-styrene block copolymer (SIS), a polystyrene-poly(ethylene-propylene) diblock copolymer (SEP), a polystyrene-poly(ethylene-propylene)-polystyrene triblock copolymer (SEPS), a styrene-ethylene-butylene-styrene block copolymer (SEBS), a polystyrene-poly(ethylene/ethylene-propylene)-polystyrene triblock copolymer (SEEPS), a styrene-isobutylene-styrene block copolymer (SIBS), and hydrides thereof.

Among these, from the viewpoint of dielectric loss tangent, heat resistance, and step followability of the polymer film, the layer A or the layer B preferably contains a thermoplastic resin containing a constitutional unit derived from a monomer having an aromatic hydrocarbon group, more preferably contains a polystyrene-based elastomer, and more preferably contains a styrene-ethylene-butylene-styrene block copolymer or a styrene-isobutylene-styrene block copolymer.

The content of the thermoplastic resin is not particularly limited, but from the viewpoint of dielectric loss tangent, heat resistance, and step followability of the polymer film, it is preferably 30% by mass to 90% by mass, and more preferably 50% by mass to 85% by mass with respect to the total mass of the layer A or the layer B.

Among these, from the viewpoint of allowing the layer A to serve as a core layer and the layer B to serve as a level difference conforming layer, it is preferable that the layer A contains a polymer having a dielectric loss tangent of 0.01 or less, and the layer B contains a thermoplastic resin containing a constitutional unit based on a monomer having an aromatic hydrocarbon group.

In addition, it is preferable that at least one of the layer A or the layer B contains a substance having an aspect ratio of 1.1 or more. In a case where the layer B contains a thermoplastic resin containing a constitutional unit based on a monomer having an aromatic hydrocarbon group, it is preferable that the layer B contains a substance having an aspect ratio of 1.1 or more.

Further, at least one of the layer A or the layer B may contain a filler in addition to the polymer and the substance having an aspect ratio of 1.1 or more.

### —Filler—

The filler may be a particulate filler or a fibrous filler, and may be an inorganic filler or an organic filler, but from the viewpoint of dielectric loss tangent, heat resistance, and step followability of the polymer film, an organic filler is preferable.

As the organic filler, a known organic filler can be used.

Examples of a material of the organic filler include polyethylene, polystyrene, urea-formalin filler, polyester, cellulose, acrylic resin, fluororesin, cured epoxy resin, crosslinked benzoguanamine resin, crosslinked acrylic resin, a liquid crystal polymer, and a material containing two or more kinds of these.

In addition, the organic filler may be fibrous, such as nanofibers, or may be hollow resin particles.

Among these, as the organic filler, from the viewpoint of the dielectric loss tangent, the heat resistance, and the step followability of the polymer film, fluororesin particles, polyester-based resin particles, polyethylene particles, liquid crystal polymer particles, or cellulose-based resin nanofibers are preferable; polytetrafluoroethylene particles, polyethylene particles, or liquid crystal polymer particles are more preferable; and liquid crystal polymer particles are particularly preferable. Here, the liquid crystal polymer particles are not limited, but refer to particles obtained by polymerizing a liquid crystal polymer and crushing the liquid crystal polymer with a crusher or the like to obtain powdery liquid crystal. The liquid crystal polymer particles are preferably smaller than the thickness of each layer.

From the viewpoint of dielectric loss tangent, heat resistance, and step followability of the polymer film, the average particle diameter of the organic filler is preferably 5 nm to 20 m and more preferably 100 nm to 10 μm.

As the inorganic filler, a known inorganic filler can be used.

Examples of a material of the inorganic filler include BN, Al₂O₃, AlN, TiO₂, SiO₂, barium titanate, strontium titanate, aluminum hydroxide, calcium carbonate, and a material containing two or more of these.

Among these, as the inorganic filler, from the viewpoint of dielectric loss tangent, heat resistance, and step followability of the polymer film, metal oxide particles or fibers are preferable, silica particles, titania particles, or glass fibers are more preferable, and silica particles or glass fibers are particularly preferable.

The average particle diameter of the inorganic filler is preferably about 20% to about 40% of the thickness of the layer A or the layer B, and for example, a value of 25%, 30%, or 35% of the thickness of the layer A or the layer B may be selected. In a case where the particles or fibers are flat, the average particle diameter indicates a length in a short side direction. In addition, from the viewpoint of dielectric loss tangent, heat resistance, and step followability of the polymer film, the average particle diameter of the inorganic filler is preferably 5 nm to 20 μm, more preferably 10 nm to 10 μm, still more preferably 20 nm to 1 μm, and particularly preferably 25 nm to 500 nm.

The layer A and the layer B may each contain only one kind of filler, or may contain two or more kinds of fillers.

In a case where the layer A contains a filler, from the viewpoint of dielectric loss tangent, heat resistance, and step followability of the polymer film, the content of the filler is preferably 10% by volume to 85% by volume, more preferably 20% by volume to 80% by volume, and particularly preferably 30% by volume to 75% by volume with respect to the total mass of the layer A.

In a case where the layer B contains a filler, from the viewpoint of dielectric loss tangent, heat resistance, and step followability of the polymer film, the content of the filler is preferably 5% by volume to 70% by volume, more preferably 10% by volume to 60% by volume, and particularly preferably 15% by volume to 50% by volume with respect to the total mass of the layer B.

Among these, it is preferable that the layer A contains a polymer having a dielectric loss tangent of 0.01 or less and an organic filler (preferably, liquid crystal polymer particles), and the layer B contains a polymer having a dielectric loss tangent of 0.01, a thermoplastic resin containing a constitutional unit based on a monomer having an aromatic hydrocarbon group, and a substance having an aspect ratio of 1.1 or more.

### —Other Additives—

The layer A and the layer B may contain other additives in addition to the above-described components.

Known additives can be used as other additives. Specific examples of the other additives include a curing agent, a leveling agent, an antifoaming agent, an antioxidant, an ultraviolet absorbing agent, a flame retardant, and a colorant.

In addition, the layer A and the layer B may contain, as other additives, a resin other than the polymer having a dielectric loss tangent of 0.01 or less.

Examples of the resin other than the polymer having a dielectric loss tangent of 0.01 or less include thermoplastic resins other than liquid crystal polyester, such as polypropylene, polyamide, polyester other than liquid crystal polyester, polyphenylene sulfide, polyether ketone, polycarbonate, polyethersulfone, polyphenylene ether and a modified product thereof, and polyetherimide; elastomers such as a copolymer of glycidyl methacrylate and polyethylene; and thermosetting resins such as a phenol resin, an epoxy resin, a polyimide resin, and a cyanate resin.

The total content of the other additives in the layer A and the layer B is preferably 25 parts by mass or less, more preferably 10 parts by mass or less, and still more preferably 5 parts by mass or less with respect to 100 parts by mass of the content of the polymer having a dielectric loss tangent of 0.01 or less.

The average thickness of the layer A is not particularly limited, but from the viewpoint of dielectric loss tangent, heat resistance, and step followability of the polymer film, the average thickness of the layer A is preferably 5 μm to 90 μm, more preferably 10 μm to 70 μm, and particularly preferably 15 μm to 50 μm.

From the viewpoint of heat resistance and step followability, the average thickness of the layer B is preferably 5 μm to 90 μm, more preferably 10 μm to 70 μm, and particularly preferably 15 μm to 50 μm.

A method for measuring the average thickness of each layer in the polymer film according to the embodiment of the present disclosure is as follows.

The polymer film is cut along a plane perpendicular to a plane direction of the polymer film, thicknesses are measured at five or more points on a cross section thereof, and an average value thereof is defined as the average thickness.

From the viewpoint of heat resistance and step followability, the polymer film according to the present disclosure preferably further includes a layer C in addition to the above-described layer A and the above-described layer B, and more preferably includes the above-described layer B, the above-described layer A, and the above-described layer C in this order.

### <Layer C>

The layer C is preferably an adhesive layer. That is, the layer C is preferably a surface layer (outermost layer).

From the viewpoint of dielectric loss tangent of the film, the layer C preferably contains at least one polymer.

The preferred aspect of the polymer used in the layer C is the same as the preferred aspect of the polymer having a dielectric loss tangent of 0.01 or less, which is used in the layer A.

The polymer contained in the layer C may be the same as or different from the polymer contained in the layer A or the layer B, but from the viewpoint of adhesiveness between the layer A and the layer C, it is preferable that the polymer contained in the layer C is the same as the polymer contained in the layer A.

In addition, since the layer C is used to bond the metal layer and the layer A, it is preferable that the layer C contains an epoxy resin.

The epoxy resin is preferably a crosslinked product of a polyfunctional epoxy compound. The polyfunctional epoxy compound refers to a compound having two or more epoxy groups. The number of epoxy groups in the polyfunctional epoxy compound is preferably 2 to 4.

In particular, from the viewpoint of dielectric loss tangent of the film and adhesiveness with the metal layer, the layer C preferably contains aromatic polyester amide and an epoxy resin.

The layer C may contain a filler.

Preferred aspects of the filler which is used in the layer C are the same as the preferred aspects of the filler which is used in the layer A or the layer B.

The layer C may contain an additive other than those described above.

Preferred aspects of other additives which are used in the layer C are the same as the preferred aspects of other additives which are used in the layer A or the layer B, except as described below.

From the viewpoint of dielectric loss tangent of the film and adhesiveness to the metal, it is preferable that an average thickness of the layer C is smaller than an average thickness of the layer A or the layer B.

From the viewpoint of dielectric loss tangent of the film and adhesiveness to the metal, a value of T^{A}/T^{C}, which is a ratio of the average thickness T^{A} of the layer A to an average thickness T^{C} of the layer C, is preferably more than 1, more preferably 2 to 100, still more preferably 2.5 to 20, and particularly preferably 3 to 10.

From the viewpoint of dielectric loss tangent of the film and adhesiveness to the metal, a value of T^{B}/T^{C}, which is a ratio of the average thickness T^{B} of the layer B to the average thickness T^{C} of the layer C, is preferably more than 1, more preferably 2 to 100, still more preferably 2.5 to 20, and particularly preferably 3 to 10.

Furthermore, from the viewpoint of dielectric loss tangent of the film and adhesiveness to the metal layer, the average thickness of the layer C is preferably 0.1 μm to 20 μm, more preferably 0.5 μm to 15 μm, still more preferably 1 μm to 10 μm, and particularly preferably 2 m to 8 μm.

From the viewpoint of strength and electrical characteristics (characteristic impedance) in a case of being laminated with the metal layer, an average thickness of the polymer film according to the embodiment of the present disclosure is preferably 6 μm to 200 μm, more preferably 12 μm to 100 μm, and particularly preferably 20 μm to 80 μm.

The average thickness of the polymer film is measured at optional five sites using an adhesive film thickness meter, for example, an electronic micrometer (product name “KG3001A”, manufactured by Anritsu Corporation), and the average value of the measured values is defined as the average thickness of the polymer film.

### <Physical Properties of Polymer Film>

In the polymer film according to the first embodiment of the present disclosure, a moisture absorption rate at a temperature of 25° C. and a relative humidity of 80% is preferably 2.5% or less.

In a case where the moisture absorption rate is 2.5% or less, moisture is less likely to be accumulated inside the polymer film, interlayer peeling is suppressed, and heat resistance is excellent.

From the viewpoint of further improving the heat resistance of the polymer film, the moisture absorption rate is more preferably 1.0% or less and still more preferably 0.5% or less. The lower limit value of the moisture absorption rate is not particularly limited, and is, for example, 0.02%.

In the present disclosure, the moisture absorption rate is measured by the following method.

The moisture content can be calculated by conditioning the polymer film at a temperature of 25° C. and a relative humidity of 80% for 24 hours, measuring the moisture content using a moisture content meter, a sample drying device “CA-03” and “VA-05” (manufactured by Mitsubishi Chemical Corporation) by Karl Fischer method, and dividing the moisture content (g) by the sample mass (g, including the moisture content).

### Second Embodiment

The polymer film according to the second embodiment of the present disclosure includes a layer having a moisture permeability of more than 560 g/(m²·day) in a case of being converted to a film thickness of 50 μm at a temperature of 80° C. and a relative humidity of 90%, and has a dielectric loss tangent of 0.01 or less.

In order to obtain a layer in which the moisture permeability at a temperature of 80° C. and a relative humidity of 90% is more than 560 g/(m²·day) in a case of being converted into a film thickness of 50 μm, it is preferable to use a material having a large free volume as a main material constituting such a layer. In addition, in order to increase the moisture permeability to be more than 560 g/(m²·day) in a case of being converted to a moisture permeability with a film thickness of 50 μm, it is also effective to add an additive having an effect of increasing the free volume.

Examples of the material having a large free volume include a material having voids or air bubbles, a polymer material having a glass transition temperature (Tg) lower than a temperature of 80° C. and a relative humidity of 90%, and the like.

Examples of the additive having an effect of increasing the free volume include a foaming agent, hollow particles, and hollow fibers.

In the present disclosure, the moisture permeability is measured by the following method.

The moisture permeability of the entire polymer film is measured using a polymer film obtained by removing a copper foil of a copper-clad laminated plate with an aqueous solution of ferric chloride, washing the copper foil with pure water, and drying the copper foil.

In addition, the moisture permeability of each layer is measured by the following method. First, one copper foil of the double-sided copper-clad laminated plate is removed with an aqueous solution of ferric chloride, washed with pure water, and then scraped off with a razor. The other copper foil is removed with an aqueous solution of ferric chloride and washed with pure water. The moisture permeability of each layer is measured using a portion obtained by drying. In addition, since the moisture permeability changes depending on the film thickness, the measured moisture permeability is multiplied by the measured film thickness and divided by 50 to obtain the “moisture permeability in a case of being converted to a moisture permeability in a case where the film thickness is 50 km”.

With reference to a moisture permeability test (cup method) of JIS Z 0208: 1976, the moisture permeability can be obtained from the mass change before and after setting the polymer film in a moisture permeation cup having an inner diameter of 20 mmφ containing calcium chloride and placing the moisture permeation cup in a constant temperature and humidity device at a temperature of 80° C. and a relative humidity of 90% for 24 hours.

From the viewpoint of heat resistance, the moisture permeability is preferably 580 g/(m²·day) or more, more preferably 620 g/(m²·day) or more, and still more preferably 650 g/(m²·day) or more in a case of being converted to a film thickness of 50 μm. The upper limit value of the moisture permeability is not particularly limited, and is, for example, 2,000 g/(m²·day).

The polymer film according to the second embodiment of the present disclosure has a dielectric loss tangent of 0.01 or less, preferably 0.005 or less, and more preferably more than 0 and 0.003 or less.

The polymer film according to the second embodiment of the present disclosure preferably has a moisture absorption rate of 2.5% or less, more preferably 1.0% or less, and still more preferably 0.5% or less at a temperature of 25° C. and a relative humidity of 80%. The lower limit value of the moisture absorption rate is not particularly limited, and is, for example, 0.03%.

In a case where the moisture absorption rate is 2.5% or less, moisture is less likely to be accumulated inside the polymer film, interlayer peeling is suppressed, and heat resistance is excellent.

The polymer film according to the second embodiment of the present disclosure may be a single layer or may be two or more layers, and from the viewpoint of step followability and heat resistance, it is preferably two or more layers. That is, the polymer film according to the second embodiment of the present disclosure preferably includes a layer A and a layer B provided on at least one surface of the layer A, and at least one of the layer A or the layer B is preferably a layer having a moisture permeability more than 560 g/(m²·day) in a case of being converted to a film thickness of 50 μm at a temperature of 80° C. and a relative humidity of 90%. The layer B is preferably a surface layer (outermost layer).

It is preferable that at least one of the layer A or the layer B includes a void. In a case where voids are included, the moisture permeability at a temperature of 80° C. and a relative humidity of 90% is more than 560 g/(m²·day). The shape of the void is not particularly limited, and examples thereof include air bubbles, hollow particles, hollow fibers, and grooves. The proportion (porosity) of the voids in the layer A or the layer B is preferably 20% to 80% and more preferably 30% to 50% with respect to the total volume of the layer A or the layer B.

In the present disclosure, the porosity is measured by the following method.

The polymer film was cut in a thickness direction with a microtome, and the cross section was observed with a scanning electron microscope. The layer to be evaluated is observed, and the porosity is measured from the area ratio between a portion where an object is present and a portion where an object is absent. The average value of the void volumes in the cross sections of the 10 positions is calculated to obtain the void volume.

The components contained in the layer A and the layer B are not particularly limited, but it is preferable that the layer A and the layer B contain at least one polymer. From the viewpoint of dielectric loss tangent of the polymer film, it is preferable that at least one of the layer A or the layer B contains a polymer having a dielectric loss tangent of 0.01 or less. The preferred aspect of the polymer having a dielectric loss tangent of 0.01 or less is the same as the preferred aspect of the polymer having a dielectric loss tangent of 0.01 or less, which can be contained in the polymer film according to the second embodiment of the present disclosure.

At least one of the layer A or the layer B preferably contains a liquid crystal polymer, and more preferably contains an aromatic polyester amide.

In addition, from the viewpoint of dielectric loss tangent and step followability of the polymer film, the layer A or the layer B preferably contains a thermoplastic resin. The preferred aspect of the thermoplastic resin is the same as the preferred aspect of the thermoplastic resin which can be contained in the polymer film according to the second embodiment of the present disclosure.

Among these, it is preferable that the layer A contains a polymer having a dielectric loss tangent of 0.01 or less, and the layer B contains a thermoplastic resin containing a constitutional unit based on a monomer having an aromatic hydrocarbon group.

### <Method of Manufacturing Polymer Film>

### (Film Formation)

A method for manufacturing the polymer film according to the embodiment of the present disclosure is not particularly limited, and a known method can be referred to.

Suitable examples of the film forming method include a co-casting method, a multilayer coating method, and a co-extrusion method. Among these, the film forming method is preferably a co-casting method.

In a case where the multilayer structure in the polymer film is manufactured by the co-casting method or the multilayer coating method, it is preferable that the co-casting method or the multilayer coating method is performed by using a composition for forming the layer A, a composition for forming the layer B, a composition for forming the layer C, or the like obtained by dissolving or dispersing components of each layer, such as the liquid crystal polymer, in a solvent.

Examples of the solvent include halogenated hydrocarbons such as dichloromethane, chloroform, 1,1-dichloroethane, 1,2-dichloroethane, 1,1,2,2-tetrachloroethane, 1-chlorobutane, chlorobenzene, and o-dichlorobenzene; halogenated phenols such as p-chlorophenol, pentachlorophenol, and pentafluorophenol; ethers such as diethyl ether, tetrahydrofuran, and 1,4-dioxane; ketones such as acetone and cyclohexanone; esters such as ethyl acetate and 7-butyrolactone; carbonates such as ethylene carbonate and propylene carbonate; amines such as triethylamine; nitrogen-containing heterocyclic aromatic compounds such as pyridine; nitriles such as acetonitrile and succinonitrile; amides such as N,N-dimethylformamide, N,N-dimethylacetamide, and N-methylpyrrolidone; urea compounds such as tetramethylurea; nitro compounds such as nitromethane and nitrobenzene; sulfur compounds such as dimethyl sulfoxide and sulfolane; and phosphorus compounds such as hexamethylphosphoramide and tri-n-butyl phosphate. Among these, two or more kinds thereof may be used in combination.

From the viewpoint of low corrosiveness and satisfactory handleability, a solvent containing, as a main component, an aprotic compound, particularly an aprotic compound having no halogen atom is preferable as the solvent, and the proportion of the aprotic compound in the entire solvent is preferably 50% by mass to 100% by mass, more preferably 70% by mass to 100% by mass, and particularly preferably 90% by mass to 100% by mass. In addition, from the viewpoint of easily dissolving the liquid crystal polymer, as the above-described aprotic compound, it is preferable to use an amide such as N,N-dimethylformamide, N,N-dimethylacetamide, tetramethylurea, and N-methylpyrrolidone, or an ester such as 7-butyrolactone; and it is more preferable to use N,N-dimethylformamide, N,N-dimethylacetamide, or N-methylpyrrolidone.

In addition, as the solvent, from the viewpoint of easily dissolving the liquid crystal polymer, a solvent containing a compound having a dipole moment of 3 to 5 as a main component is preferable, and a proportion of the compound having a dipole moment of 3 to 5 in the entire solvent is preferably 50% by mass to 100% by mass, more preferably 70% by mass to 100% by mass, and particularly preferably 90% by mass to 100% by mass.

It is preferable to use the compound having a dipole moment of 3 to 5 as the above-described aprotic compound.

In addition, as the solvent, from the viewpoint of ease removal, a solvent containing, as a main component, a compound having a boiling point of 220° C. or lower at 1 atm is preferable, and a proportion of the compound having a boiling point of 220° C. or lower at 1 atm in the entire solvent is preferably 50% by mass to 100% by mass, more preferably 70% by mass to 100% by mass, and particularly preferably 90% by mass to 100% by mass.

It is preferable to use the compound having a boiling point of 220° C. or lower at 1 atm as the above-described aprotic compound.

In addition, in the method for manufacturing the polymer film according to the embodiment of the present disclosure, in a case where the polymer film is manufactured by the co-casting method, the multilayer coating method, the co-extrusion method, or the like, a support may be used.

Examples of the support include a metal drum, a metal band, a glass plate, a resin film, and a metal foil. Among these, the support is preferably a metal drum, a metal band, or a resin film.

Examples of the resin film include a polyimide (PI) film, and examples of commercially available products thereof include U-PILEX S and U-PILEX R (manufactured by Ube Corporation), KAPTON (manufactured by Du Pont-Toray Co., Ltd.), and IF30, IF70, and LV300 (manufactured by SKC Kolon PI, Inc.).

In addition, the support may have a surface treatment layer formed on the surface so that the support can be easily peeled off. Hard chrome plating, a fluororesin, or the like can be used as the surface treatment layer.

An average thickness of the resin film support is not particularly limited, but is preferably 25 μm or more and 75 μm or less and more preferably 50 μm or more and 75 μm.

In addition, a method for removing at least a part of the solvent from a cast or applied film-like composition (a coating film) is not particularly limited, and a known drying method can be used.

### (Stretching)

In the polymer film according to the embodiment of the present disclosure, stretching can be combined as appropriate from the viewpoint of controlling molecular alignment and adjusting thermal expansion coefficient and mechanical properties. The stretching method is not particularly limited, and a known method can be referred to, and the stretching method may be carried out in a solvent-containing state or in a dry film state. The stretching in the solvent-containing state may be carried out by gripping and stretching the film, or may be carried out by utilizing self-contraction due to drying without stretching. The stretching is particularly effective for the purpose of improving the breaking elongation and the breaking strength, in a case where brittleness of the film is reduced by addition of an inorganic filler or the like.

### <Applications>

The polymer film according to the embodiment of the present disclosure can be used for various applications. Among the various applications, the polymer film can be used suitably as a film for an electronic component such as a printed wiring board and more suitably for a flexible printed circuit board.

In addition, the polymer film according to the present disclosure can be suitably used as a liquid crystal polymer film for metal adhesion.

### [Laminate]

It is sufficient that the laminate according to the embodiment of the present disclosure is a laminate including the polymer film according to the embodiment of the present disclosure. The laminate according to the present disclosure preferably includes the polymer film according to the present disclosure and a metal layer or a metal wire disposed on at least one surface of the polymer film, and it is more preferable that the metal layer or the metal wire is a copper layer or a copper wire.

In addition, the laminate according to the present disclosure preferably has the polymer film according to the present disclosure having the layer A and the layer B, and a metal layer or a metal wire disposed on a surface of the polymer film on a layer A side, and it is more preferable that the metal layer or the metal wire is a copper layer or a copper wire.

In addition, the laminate according to the present disclosure preferably has the polymer film according to the present disclosure including the layer B, the layer A, and the layer C in this order, and a metal layer or a metal wire disposed on a surface of the polymer film on a layer C side, and it is more preferable that the metal layer or the metal wire is a copper layer or a copper wire.

In a case where a metal layer or a metal wire is disposed on both surfaces of the polymer film, the two metal layers or metal wires may be metal layers or metal wires having the same material, thickness, and shape, or may be metal layers having different materials, thicknesses, and shapes. From the viewpoint of adjusting the characteristic impedance, the two metal layers or metal wires may be metal layers or metal wires having different materials and thicknesses.

The above-described metal layer and metal wire are not particularly limited and may be any known metal layer or metal wire, but for example, a silver layer, a silver wire, a copper layer, or a copper wire is preferable, and a copper layer or a copper wire is more preferable.

Further, from the viewpoint of adjusting the characteristic impedance, an aspect in which a metal layer or a metal wire is laminated on one side of the layer B or the layer C and another film (preferably, another polymer film) is laminated on the other side is also preferable.

A peel strength between the above-described polymer film and the above-described metal layer is preferably 0.5 kN/m or more, more preferably 0.7 kN/m or more, still more preferably 0.7 kN/m to 2.0 kN/m, and particularly preferably 0.9 kN/m to 1.5 kN/m.

In the present disclosure, the peel strength between the polymer film and the metal layer (for example, the copper layer) is measured by the following method.

A peeling test piece with a width of 1.0 cm is produced from the laminate of the polymer film and the metal layer, the film is fixed to a flat plate with double-sided adhesive tape, and the strength (kN/m) in a case of peeling the polymer film off from the metal layer at a rate of 50 mm/min is measured by the 180° method in conformity with JIS C 5016 (1994).

The metal layer is preferably a silver layer or a copper layer, and more preferably a copper layer. As the copper layer, a rolled copper foil formed by a rolling method or an electrolytic copper foil formed by an electrolytic method is preferable, and a rolled copper foil is more preferable from the viewpoint of bending resistance.

An average thickness of the metal layer, preferably the copper layer, is not particularly limited, but is preferably 2 μm to 20 μm, more preferably 3 μm to 18 μm, and still more preferably 5 μm to 12 μm. The copper foil may be copper foil with a carrier formed on a support (carrier) so as to be peelable. As the carrier, a known carrier can be used. An average thickness of the carrier is not particularly limited, but is preferably 10 μm to 100 μm and more preferably 18 μm to 50 μm.

From the viewpoint of suppressing the distortion of the metal wire in a case where the film is adhered to the metal wire, it is preferable that a thickness of the layer B is larger than a thickness of the metal layer (for example, the copper layer).

The metal layer in the laminate according to the embodiment of the present disclosure may be a metal layer having a circuit pattern.

It is also preferable that the metal layer in the laminate according to the embodiment of the present disclosure is processed into, for example, a desired circuit pattern by etching to form a flexible printed circuit board. The etching method is not particularly limited, and a known etching method can be used.

### EXAMPLES

Hereinafter, the present disclosure will be described in more detail with reference to Examples. The materials, the used amounts, the proportions, the treatment contents, the treatment procedures, and the like described in the following examples can be appropriately changed without departing from the gist of the present disclosure. Therefore, the scope of the present disclosure is not limited to the following specific examples.

The details of the polymer and the additive (components other than the polymer) used in the production of the layer A, the layer B, the layer C, and the layer D, and the copper foil are as follows.

### <Polymer>

LC-A: aromatic polyester amide (liquid crystal polymer) produced by the production method described below

### —Synthesis of Aromatic Polyester Amide LC-A—

940.9 g (5.0 mol) of 6-hydroxy-2-naphthoic acid, 415.3 g (2.5 mol) of isophthalic acid, 377.9 g (2.5 mol) of acetaminophen, 867.8 g (8.4 mol) of acetic anhydride are put in a reactor comprising a stirring device, a torque meter, a nitrogen gas introduction pipe, a thermometer, and a reflux condenser, gas in the reactor is substituted with nitrogen gas, a temperature increases from a room temperature (23° C., the same applies hereinafter) to 140° C. over 60 minutes while stirring under a nitrogen gas flow, and refluxing is performed at 140° C. for three hours.

Next, the temperature was raised from 150° C. to 300° C. over 5 hours while distilling off by-produced acetic acid and unreacted acetic anhydride, and maintained at 300° C. for 30 minutes. Thereafter, a content is taken out from the reactor and is cooled to the room temperature. The obtained solid was pulverized by a pulverizer to obtain a powdered aromatic polyester amide Ala. A flow start temperature of the aromatic polyester amide Ala was 193° C. In addition, the aromatic polyester amide Ala was a fully aromatic polyester amide.

The aromatic polyester amide Ala was subjected to solid polymerization by increasing the temperature from room temperature to 160° C. over 2 hours and 20 minutes in a nitrogen atmosphere, increasing the temperature from 160° C. to 180° C. over 3 hours and 20 minutes, and maintaining the temperature at 180° C. for 5 hours, and then the resultant was cooled. Next, the resultant was pulverized by a pulverizer to obtain a powdered aromatic polyester amide Alb. A flow start temperature of the aromatic polyester amide Alb was 220° C.

The aromatic polyester amide Alb was subjected to solid polymerization by increasing the temperature from room temperature to 180° C. over 1 hour and 25 minutes in a nitrogen atmosphere, increasing the temperature from 180° C. to 255° C. over 6 hours and 40 minutes, and maintaining the temperature at 255° C. for 5 hours, and then the resultant was cooled, thereby obtaining a powdered aromatic polyester amide LC-A.

The flow start temperature of the aromatic polyester amide LC-A was 302° C. In addition, in a case where a melting point of the aromatic polyester amide LC-A was measured using a differential scanning calorimetry device, the measured value was 311° C. The dielectric loss tangent of aromatic polyester amide LC-A was 0.005.

### <Additive>

F-1 (LCP particles): liquid crystal polymer particles produced by the following production method
F-2 (SEBS particles: hydrogenated styrene-ethylene-butylene-styrene block copolymer particles, frozen pulverized product of TUFTEC M1913 manufactured by Asahi Kasei Corporation (average particle diameter: 5.0 μm (D50))
A-1 (curing agent): aminophenol-type epoxy resin, product name “jER630”, manufactured by Mitsubishi Chemical Corporation
F-3 (isotropic filler 1: boron nitride, product name “HP-P1”, manufactured by JFE Mineral Co., Ltd., aspect ratio >1.1
F-4 (isotropic filler 2: synthetic mica, product name “ME-X22-DS”, manufactured by Katakura Industries, aspect ratio >1.1
F-5 (hollow particles): product name “Glass Bubbles iM30K”, manufactured by 3M Japan Limited, average particle diameter (D50) 16 μm, aspect ratio 1.0
F-6 (anisotropic hollow particles): hollow silica, thickness of shell: 30 nm, hollow ratio: 66%, particle diameter: 0.95 μm, aspect ratio: 3.3
B-1 (foaming agent): acrylic resin fine particles, product name “Finesphere MG-351”, manufactured by Nippon Paint Industrial Coatings Co., Ltd., thermal decomposition start temperature: 250° C.

### —Production of F-1 (LCP Particles)—

1034.99 g (5.5 mol) of 2-hydroxy-6-naphthoic acid, 89.18 g (0.41 mol) of 2,6-naphthalenedicarboxylic acid, 236.06 g (1.42 mol) of terephthalic acid, 341.39 g (1.83 mol) of 4,4-dihydroxybiphenyl, and potassium acetate and magnesium acetate as a catalyst were put in a reactor including a stirring device, a torque meter, a nitrogen gas introduction pipe, a thermometer, and a reflux condenser. The gas in the reactor was replaced with nitrogen gas, and acetic anhydride (1.08 molar equivalent with respect to a hydroxyl group) was further added thereto. The temperature was raised from room temperature to 150° C. over 15 minutes while stirring in a nitrogen gas stream, and refluxing was performed at 150° C. for 2 hours.

Next, the temperature was raised from 150° C. to 310° C. over 5 hours while distilling off by-produced acetic acid and unreacted acetic anhydride, and a polymerized substance was cooled to room temperature. An obtained polymerized substance increases in temperature from the room temperature to 295° C. over 14 hours, and is subjected to solid polymerization at 295° C. for one hour. After the solid polymerization, the mixture was cooled to room temperature over 5 hours.

The obtained liquid crystal polyester was crushed using a jet mill (“KJ-200” manufactured by KURIMOTO LTD.) to obtain F-1 (LCP particles). F-1 (LCP particles) had a median diameter (D50) of 7 μm, a dielectric loss tangent of 0.0007, and a melting point of 334° C.

### <Copper Foil>

M1: product name “CF-T9DA-SV-18”, manufactured by Fukuda Metal Foil & Powder Co., Ltd., average thickness: 18 μm
M2: product name “CF-T4X-SV-18”, manufactured by Fukuda Metal Foil & Powder Co., Ltd., average thickness: 18 μm
M3: product name “MT18FL”, manufactured by Mitsui Mining & Smelting Co., Ltd., average thickness: 1.5 μm, with 18 μm carrier foil

### Examples 1-1 to 1-8, Examples 2-1 to 2-6, Comparative Examples 1 and 2

Examples 1-1 to 1-8 are examples corresponding to the first embodiment of the polymer film according to the present disclosure, and Examples 2-1 to 2-6 are examples corresponding to the second embodiment of the polymer film according to the present disclosure.

### —Preparation of Solution for Layer C—

8 parts of aromatic polyester amide LC-A was added to 92 parts of N-methylpyrrolidone, and the mixture was stirred at 140° C. for 4 hours in a nitrogen atmosphere to obtain a solution of aromatic polyester amide LC-A (concentration of solid contents: 8% by mass).

A solution of aromatic polyester amide LC-A and additives were mixed so as to have a composition containing the polymer and the additives at the mass ratios shown in Table 1, thereby preparing a solution for a layer C.

### —Preparation of Solution for Layer A—

The solution of aromatic polyester amide LC-A and the additives were mixed so as to obtain a composition containing the polymer and the additives having the mass ratios shown in Table 1, and N-methylpyrrolidone was added thereto to adjust the concentration of solid contents to 25% by mass, thereby obtaining a solution for a layer A.

### —Preparation of Solution for Layer B—

The solution of the aromatic polyester amide LC-A and the additives were mixed so as to have a composition containing the polymer and the additives having the mass ratios shown in Table 1, and N-methylpyrrolidone was added thereto to adjust the concentration of solid contents to 20% by mass, thereby obtaining a solution for a layer B.

### —Preparation of Single-Sided Copper-Clad Laminated Plate—

The obtained solution for a layer C, the solution for a layer A, and the solution for a layer B were fed to a slot die coater equipped with a slide coater, and applied onto the treated surface of the copper foil shown in Table 1 in a three-layer configuration (layer C/layer A/layer B) by adjusting the flow rate so that the thickness after drying was the thickness shown in Table 1. The solvent was removed from the coating film by drying at 40° C. for 4 hours. The temperature was further raised from room temperature to 300° C. at 1° C./min in a nitrogen atmosphere, and the heat treatment was performed for 2 hours at that temperature to obtain a polymer film having a copper layer (a single-sided copper-clad laminated plate).

In Examples 2-1 to 2-3, the foaming agent B-1 was added to the solution for the layer B, and in the heat treatment step under a nitrogen atmosphere, the B-1 was thermally decomposed to obtain a polymer film (single-sided copper-clad laminated plate) having a void in the layer B. The porosity was adjusted by the adding amount of B-1 added to the solution for the layer B.

In addition, in Example 2-6, a polymer film (single-sided copper-clad laminated plate) having a cavity in the layer A was obtained by placing a commercially available polyester-based hollow fiber membrane on the treated surface of the copper foil and applying the membrane.

### —Production of Double-Sided Copper-Clad Laminated Plate—

The copper foil and the single-sided copper-clad laminated plate were laminated in this order such that the treated surface of the copper foil shown in Table 1 was in contact with the layer B of the single-sided copper-clad laminated plate. A double-sided copper-clad laminated plate precursor was obtained by performing a laminating treatment for 1 minute under conditions of 140° C. and a laminating pressure of 0.4 MPa using a laminator (product name “Vacuum Laminator V-130”, manufactured by Nikko-Materials Co., Ltd.). Subsequently, using a thermal compression machine (product name “MP-SNL”, manufactured by Toyo Seiki Seisaku-sho, Ltd.), the obtained double-sided copper-clad laminated plate precursor was thermally compression-bonded for 60 minutes under conditions of 200° C. and 4 MPa to prepare a double-sided copper-clad laminated plate.

Using the obtained double-sided copper-clad laminated plate or single-sided copper-clad laminated plate, the moisture permeability of the layer A and the layer B at a temperature of 80° C. and a relative humidity of 90%, the moisture absorption rate of the polymer film at a temperature of 25° C. and a relative humidity of 80%, and the dielectric loss tangent of the polymer film were measured. The measuring methods were as follows. In a case where the copper foil M2 was used, after the copper-clad laminated plate described above was produced, the carrier foil of M2 was peeled off and removed, and copper plating was performed on the surface that appeared, thereby completing the copper-clad laminated plate. In addition, in a case of patterning, a known dry film resist was bonded to a surface that appeared after removing the carrier foil, patterning was performed by a known photofabrication method, copper plating was performed, and the remaining dry film resist was removed to complete a desired wiring board.

### <Dielectric Loss Tangent>

The dielectric loss tangent was measured by a resonance perturbation method at a frequency of 10 GHz. A 10 GHz cavity resonator (“CP531” manufactured by Kanto Electronic Application & Development Inc.) was connected to a network analyzer (“E8363B” manufactured by Agilent Technology Co., Ltd.), a polymer film was inserted into the cavity resonator, and the dielectric loss tangent of the polymer film was measured from a change in resonance frequency before and after the insertion for 96 hours in an environment of a temperature of 25° C. and a humidity of 60% RH.

### <Moisture Absorption Rate>

The metal layer of the double-sided copper-clad laminated plate was etched to take out the polymer film.

The polymer film was conditioned at a temperature of 25° C. and a relative humidity of 80% for 24 hours, and then measured by a Karl Fischer method with a moisture content meter and a sample drying device “CA-03” and “VA-05” (manufactured by Mitsubishi Chemical Corporation), and the moisture content (g) was calculated by dividing the moisture content (g) by the sample mass (g, including the moisture content).

### <Moisture Permeability>

The moisture permeability of the entire polymer film was measured using a polymer film obtained by removing a copper foil of a copper-clad laminated plate with an aqueous solution of ferric chloride, washing the copper foil with pure water, and then drying the copper foil.

In addition, the moisture permeability of each layer was measured by the following method. First, one copper foil of the double-sided copper-clad laminated plate is removed with an aqueous solution of ferric chloride, washed with pure water, and then scraped off with a razor. The other copper foil was removed with an aqueous solution of ferric chloride and washed with pure water. The moisture permeability of each layer was measured using the portion obtained by drying.

### (First Moisture Permeability)

The copper foil of the copper-clad laminated plate was removed with an aqueous solution of ferric chloride, washed with pure water, and dried to obtain a polymer film. The obtained polymer film was laminated and then subjected to thermal compression bonding using a vacuum press device to prepare a block-shaped sample, and the obtained sample was cut in the normal direction of the film and polished to prepare a sample for evaluation having a thickness of 1 mm. The first moisture permeability was obtained from a mass change before and after setting the sample for evaluation in a moisture permeation cup having an inner diameter of 20 mmφ containing calcium chloride and placing the moisture permeation cup in a constant temperature and humidity device at a temperature of 80° C. and a relative humidity of 90% for 240 hours.

### (Second Moisture Permeability)

With reference to a moisture permeability test (cup method) of JIS Z 0208: 1976, the second moisture permeability was obtained from a mass change before and after setting the polymer film in a moisture permeation cup having an inner diameter of 20 mmφ containing calcium chloride and placing the moisture permeation cup in a constant temperature and humidity device at a temperature of 80° C. and a relative humidity of 90% for 24 hours.

Using the obtained double-sided copper-clad laminated plate or single-sided copper-clad laminated plate, the step followability and the heat resistance were evaluated. The evaluation method was as follows.

### <Step Followability>

Using the prepared copper-clad laminated plate, a flexible wiring board having a four-layer stripline structure of an outer layer plane (ground layer) was produced.

### —Step of Forming Wiring Base Material—

The copper foil of the above-described double-sided copper-clad laminated plate was patterned by a known photofabrication method to produce a wiring base material including three pairs of signal lines. A length of the signal line was 100 mm, and a width of the signal line was set such that characteristic impedance was 50Ω.

### —Lamination Step—

Using the above-described wiring base material and a pair of the above-described single-sided copper-clad laminated plates, a laminate of single-sided copper-clad laminated plate/wiring base material/single-sided copper-clad laminated plate was formed such that the wiring base material was in contact with the film side of the single-sided copper-clad laminated plate. Using a vacuum press device, the metal wires were laminated at a press temperature of 160° C. to produce a flexible wiring board.

Evaluation regarding distortion of wiring line was performed using the produced flexible wiring board. The evaluation methods were as follows. The evaluation results are shown in Table 2.

The flexible wiring board was cut with a microtome, the cross section was observed with an optical microscope, and the distortion of the wiring line was evaluated based on the following evaluation standard.
A: No distortion was recognized in the signal lines and the ground line.
B: While no distortion was recognized in the signal lines, distortion was recognized in the ground line.
C: Distortion was recognized in a pair of signal lines.
D: Distortion was recognized in two pairs or three pairs of signal lines.

### <Heat Resistance>

The produced double-sided copper-clad laminated plate was cut out into 30 mm×30 mm, and treated in a constant temperature and humidity tank at a temperature of 85° C. and a relative humidity of 85% for 168 hours. A sample treated in an oven at 260° C. was placed therein. The sample after heating for 15 minutes was cut with a razor, and the cross section was observed with an optical microscope, and the peeling state was evaluated based on the following evaluation standards.
A: No peeling was observed.
B: Peeling was recognized with a width of 1 mm or less.
C: peeling was recognized in a width of more than 1 mm.

The evaluation results are shown in Table 1. In Table 1, the moisture permeability means a moisture permeability in a film thickness direction in a case of being converted to a film thickness of 50 μm at a temperature of 80° C. and a relative humidity of 90%, and the unit thereof is “g/(m² day)”. The moisture absorption rate means a moisture absorption rate at a temperature of 25° C. and a relative humidity of 80%, and the unit thereof is “%”. The “first moisture transmission rate/second moisture transmission rate” means a ratio of the first moisture transmission rate to the second moisture transmission rate in a case where a moisture transmission rate at 80° C. and a relative humidity of 90% in a first direction parallel to the main surface is defined as the first moisture transmission rate, and a moisture transmission rate at 80° C. and a relative humidity of 90% in a second direction which is a thickness direction orthogonal to the first direction is defined as the second moisture transmission rate. The dichroic ratio means a ratio of a first absorbance to a second absorbance in a case where a first absorbance is an absorbance of a substance having an aspect ratio of 1.1 or more in the first direction and a second absorbance is an absorbance of a substance having an aspect ratio of 1.1 or more in the second direction.

TABLE 1

| | | | Comparative | Comparadive | Example | Example | Example | Example | Example | Example |
|---|---|---|---|---|---|---|---|---|---|---|
| | | | Example 1 | Example 2 | 1-1 | 1-2 | 1-3 | 1-4 | 1-5 | 1-6 |
| Foil | | | M1 | M2 | M1 | M1 | M3 | M1 | M1 | M1 |
| Layer D | Polymer | Kind | — | — | — | — | — | — | — | LC-A |
| | | Content | | | | | | | | 20 |
| | | (% by mass) | | | | | | | | |
| | Additive | Kind | | | | | | | | F-2 |
| | 1 | Content | | | | | | | | 40 |
| | | (% by mass) | | | | | | | | |
| | Additive | Kind | | | | | | | | F-3 |
| | 2 | Content | | | | | | | | 40 |
| | | (% by mass) | | | | | | | | |
| | Thickness (μm) | | | | | | | | | 3 |
| Layer B | Polymer | Kind | LC-A | — | — | LC-A | LC-A | LC-A | LC-A | LC-A |
| | | Content | 20 | | | 20 | 20 | 20 | 20 | 20 |
| | | (% by mass) | | | | | | | | |
| | Additive | Kind | F-2 | | | F-2 | F-2 | F-2 | F-2 | F-2 |
| | | Content | 80 | | | 50 | 50 | 50 | 55 | 80 |
| | | (% by mass) | | | | | | | | |
| | Additive | Kind | — | | | F-3 | F-3 | F-4 | F-6 | — |
| | 2 | Content | | | | 30 | 30 | 30 | 25 | |
| | | (% by mass) | | | | | | | | |
| | Porosity (%) | | — | | | — | — | — | — | — |
| | Thickness (μm) | | 25 | | | 25 | 25 | 25 | 25 | 22 |
| Layer A | Polymer | Kind | LC-A | LC-A | LC-A | LC-A | LC-A | LC-A | LC-A | LC-A |
| | | Content | 25 | 25 | 25 | 25 | 25 | 25 | 25 | 25 |
| | | (% by mass) | | | | | | | | |
| | Additive | Kind | F-1 | F-1 | F-1 | F-1 | F-1 | F-1 | F-1 | F-1 |
| | 1 | Content | 75 | 75 | 50 | 75 | 75 | 75 | 75 | 75 |
| | | (% by mass) | | | | | | | | |
| | Additive | Kind | — | — | F-3 | — | — | — | — | — |
| | 2 | Content | | | 30 | | | | 1 | |
| | | (% by mass) | | | | | | | | |
| | Porosity (%) | | — | — | — | — | — | — | — | — |
| | Thickness (μm) | | 22 | 50 | 50 | 22 | 22 | 22 | 22 | 22 |
| Layer C | Polymer | Kind | LC-A | — | — | LC-A | LC-A | LC-A | LC-A | LC-A |
| | | Content | 99.6 | | | 99.6 | 99.6 | 99.6 | 99.6 | 99.6 |
| | | (% by mass) | | | | | | | | |
| | Additive | Kind | A-1 | | | A-1 | A-1 | A-1 | A-1 | A-1 |
| | 1 | Content | 0.4 | | | 0.4 | 0.4 | 0.4 | 0.4 | 0.4 |
| | | (% by mass) | | | | | | | | |

| | Thickness (μm) | 3 | | | 3 | 3 | 3 | 3 | 3 |
|---|---|---|---|---|---|---|---|---|---|
| First moisture transmission rate/ | | 1.00 | 1.00 | >1.00 | >1.00 | >1.00 | >1.00 | >1.00 | >1.00 |
| second moisture transmission rate | | | | | | | | | |
| Moisture | Layer B | 560 | — | — | 220 | 220 | 280 | 420 | 520 |
| permeability | Layer A | 0.5 | 0.5 | 4 | 0.5 | 0.5 | 0.5 | 0.5 | 0.5 |
| Dichroic ratio | | 1.00 | 1.00 | >1.00 | >1.00 | >1.00 | >1.00 | >1.00 | >1.00 |
| Moisture absorption rate | | 0.3 | 0.2 | 0.3 | 0.2 | 0.2 | 0.2 | 0.2 | 0.3 |
| Dielectric loss tangent | | 0.003 | 0.002 | 0.005 | 0.004 | 0.004 | 0.005 | 0.005 | 0.003 |
| Evaluation | Step followability | A | C | B | B | B | B | A | A |
| | Heat resistance | C | A | A | A | A | A | A | A |

| | | | Example | Example | Example | Example | Example | Example | Example | Example |
|---|---|---|---|---|---|---|---|---|---|---|
| | | | 1-7 | 1-8 | 2-1 | 2-2 | 2-3 | 2-4 | 2-5 | 2-6 |
| Foil | | | M3 | M1 | M1 | M1 | M1 | M1 | M1 | M1 |
| Layer D | Polymer | Kind | LC-A | LC-A | — | — | — | — | — | — |
| | | Content | 20 | 20 | | | | | | |
| | | (% by mass) | | | | | | | | |
| | Additive | Kind | F-2 | F-2 | | | | | | |
| | 1 | Content | 40 | 40 | | | | | | |
| | | (% by mass) | | | | | | | | |
| | Additive | Kind | F-3 | F-4 | | | | | | |
| | 2 | Content | 40 | 40 | | | | | | |
| | | (% by mass) | | | | | | | | |
| | Thickness (μm) | | 3 | 3 | | | | | | |
| Layer B | Polymer | Kind | LC-A | LC-A | LC-A | LC-A | LC-A | LC-A | LC-A | LC-A |
| | | Content | 20 | 20 | 20 | 20 | 20 | 20 | 20 | 20 |
| | | (% by mass) | | | | | | | | |
| | Additive | Kind | F-2 | F-2 | F-2 | F-2 | F-2 | F-2 | F-2 | F-2 |
| | | Content | 80 | 80 | 80 | 80 | 80 | 50 | 80 | 80 |
| | | (% by mass) | | | | | | | | |
| | Additive | Kind | — | — | — | — | — | F-5 | — | — |
| | 2 | Content | | | | | | 30 | | |
| | | (% by mass) | | | | | | | | |
| | Porosity (%) | | — | — | 10 | 20 | 30 | 18 | 0 | 0 |
| | Thickness (μm) | | 22 | 22 | 25 | 25 | 25 | 25 | 25 | 25 |
| Layer A | Polymer | Kind | LC-A | LC-A | LC-A | LC-A | LC-A | LC-A | LC-A | LC-A |
| | | Content | 25 | 25 | 25 | 25 | 25 | 25 | 25 | 25 |
| | | (% by mass) | | | | | | | | |
| | Additive | Kind | F-1 | F-1 | F-1 | F-1 | F-1 | F-1 | F-1 | F-1 |
| | 1 | Content | 75 | 75 | 75 | 75 | 75 | 75 | 15 | 75 |
| | | (% by mass) | | | | | | | | |
| | Additive | Kind | — | — | — | — | — | — | F-5 | — |
| | 2 | Content | | | | | | | 60 | |
| | | (% by mass) | | | | | | | | |
| | Porosity (%) | | — | — | — | — | — | — | 36 | 30 |
| | Thickness (μm) | | 22 | 22 | 22 | 22 | 23 | 22 | 25 | 25 |
| Layer C | Polymer | Kind | LC-A | LC-A | LC-A | LC-A | LC-A | LC-A | LC-A | LC-A |
| | | Content | 99.6 | 99.6 | 99.6 | 99.6 | 94.8 | 99.6 | 99.6 | 99.6 |
| | | (% by mass) | | | | | | | | |
| | Additive | Kind | A-1 | A-1 | A-1 | A-1 | A-1 | A-1 | A-1 | A-1 |
| | 1 | Content | 0.4 | 0.4 | 0.4 | 0.4 | 0.4 | 0.4 | 0.4 | 0.4 |
| | | (% by mass) | | | | | | | | |

| | Thickness (μm) | 3 | 3 | 3 | 3 | 3 | 3 | 3 | 3 |
|---|---|---|---|---|---|---|---|---|---|
| First moisture transmission rate/ | | >1.00 | >1.00 | 1.00 | 1.00 | 1.00 | 1.00 | 1.00 | >1.00 |
| second moisture transmission rate | | | | | | | | | |
| Moisture | Layer B | 520 | 520 | 570 | 620 | 880 | 760 | 560 | 560 |
| permeability | Layer A | 0.5 | 0.5 | 0.5 | 0.5 | 0.5 | 0.5 | 650 | 680 |
| Dichroic ratio | | >1.00 | >1.00 | 1.00 | 1.00 | 1.00 | 1.00 | 1.00 | >1.00 |
| Moisture absorption rate | | 0.3 | 0.3 | 0.3 | 0.3 | 0.2 | 0.2 | 0.3 | 0.2 |
| Dielectric loss tangent | | 0.003 | 0.003 | 0.003 | 0.003 | 0.002 | 0.002 | 0.003 | 0.004 |
| Evaluation | Step followability | A | A | A | A | A | B | A | A |
| | Heat resistance | A | A | B | A | A | A | A | A |

As shown in Table 1, in Examples 1-1 to 1-8, in a case where the moisture transmission rate at 80° C. and a relative humidity of 90% in the first direction parallel to the main surface is defined as the first moisture transmission rate and the moisture transmission rate at 80° C. and a relative humidity of 90% in the second direction which is the thickness direction orthogonal to the first direction is defined as the second moisture transmission rate, the ratio of the first moisture transmission rate to the second moisture transmission rate is more than 1.00, and thus the step followability and the heat resistance are excellent.

In addition, in Examples 2-1 to 2-6, the permeation rate at a temperature of 80° C. and a relative humidity of 90% includes a layer having a permeation rate more than 560 g/(m²·day) in a case of being converted to a film thickness of 50 μm, and the dielectric loss tangent is 0.01 or less. Therefore, the step followability and heat resistance are excellent.

The disclosure of Japanese Patent Application No. 2022-175012 filed on Oct. 31, 2022 is incorporated in the present specification by reference. In addition, all documents, patent applications, and technical standards described in the present specification are herein incorporated by reference to the same extent that each individual document, patent application, or technical standard was specifically and individually indicated to be incorporated by reference.

What is claimed is:

1. A polymer film,
wherein in a case where a moisture transmission rate at 80° C. and a relative humidity of 90% in a first direction parallel to a main surface is defined as a first moisture transmission rate and a moisture transmission rate at 80° C. and a relative humidity of 90% in a second direction which is a thickness direction orthogonal to the first direction is defined as a second moisture transmission rate, a ratio of the first moisture transmission rate to the second moisture transmission rate is more than 1.00.

2. The polymer film according to claim 1,
wherein the polymer film has a dielectric loss tangent of 0.01 or less.

3. The polymer film according to claim 1, further comprising:
a substance having an aspect ratio of 1.1 or more.

4. The polymer film according to claim 3,
wherein in a case where an absorbance of the substance in the first direction is defined as a first absorbance and an absorbance of the substance in the second direction is defined as a second absorbance, a ratio of the first absorbance to the second absorbance is more than 1.00.

5. The polymer film according to claim 1, further comprising:
a layer A; and
a layer B provided on at least one surface of the layer A.

6. The polymer film according to claim 5,
wherein at least one of the layer A or the layer B contains a polymer having a dielectric loss tangent of 0.01 or less.

7. The polymer film according to claim 6,
wherein the polymer having a dielectric loss tangent of 0.01 or less contains a liquid crystal polymer.

8. The polymer film according to claim 7,
wherein the liquid crystal polymer contains an aromatic polyester amide.

9. The polymer film according to claim 5,
wherein the layer A contains a polymer having a dielectric loss tangent of 0.01 or less, and
the layer B contains a thermoplastic resin containing a constitutional unit based on a monomer having an aromatic hydrocarbon group.

10. A polymer film comprising:
a layer having a moisture permeability of more than 560 g/(m²·day) at a temperature of 80° C. and a relative humidity of 90% in a case of being converted to a film thickness of 50 μm,
wherein the polymer film has a dielectric loss tangent of 0.01 or less.

11. The polymer film according to claim 10,
wherein the polymer film has a moisture absorption rate of 2.5% or less at a temperature of 25° C. and a relative humidity of 80%.

12. The polymer film according to claim 10, further comprising:
a layer A; and
a layer B provided on at least one surface of the layer A,
wherein at least one of the layer A or the layer B is the layer having a moisture permeability of more than 560 g/(m²·day) at a temperature of 80° C. and a relative humidity of 90% in a case of being converted to a film thickness of 50 μm.

13. The polymer film according to claim 12,
wherein at least one of the layer A or the layer B includes a void.

14. The polymer film according to claim 12,
wherein at least one of the layer A or the layer B contains a polymer having a dielectric loss tangent of 0.01 or less.

15. The polymer film according to claim 14,
wherein the polymer having a dielectric loss tangent of 0.01 or less contains a liquid crystal polymer.

16. The polymer film according to claim 15,
wherein the liquid crystal polymer contains an aromatic polyester amide.

17. The polymer film according to claim 12,
wherein the layer A contains a polymer having a dielectric loss tangent of 0.01 or less, and
the layer B contains a thermoplastic resin containing a constitutional unit based on a monomer having an aromatic hydrocarbon group.

18. A laminate comprising:
the polymer film according to claim 1; and
a metal layer or a metal wire, disposed on at least one surface of the polymer film.

19. The laminate according to claim 18,
wherein a peel strength between the polymer film and the metal layer or the metal wire is 0.5 kN/m or more.
